(19) United States
(12) Patent Application Publication
(10) Pub. No.: US 2003/0207971 A1
(43) Pub. Date: Nov. 6, 2003

(54) Emollient gel

(75) Inventors: James A. Stuart JR., Hartland, WI (US); Bruce A. Tavares, Hartland, WI (US)

Correspondence Address: Alfred D. Lobo, Lobo & Co., LPA, 933 The Leader Bldg., 526 Superior Avenue, E., Cleveland, OH, 44114, US

(73) Assignee: React of Delafield LLC, Delafield, WI (US)

(21) Appl. No.: 10/436,555

(22) Filed: May 13, 2003

Related U.S. Application Data
(63) Continuation of application No. 10/126,414, filed on Apr. 19, 2002, now abandoned.
Application No. 10/126,414 is a continuation-in-part of application No. 09/994,416, filed on Nov. 27, 2001, now abandoned.

(51) Int. Cl. C08K 5/01

(52) U.S. Cl. 524/274; 524/474

(57) ABSTRACT

An emollient gel useful as an ingredient in inks, paint, lubricants, grease and cosmetics, and particularly as a replacement for petrolatum in such applications. The emollient gel is composed of 40-98% of an oil, or blend of oils, and 2-60% of a thickening wax, or blend of thickening waxes. The oil is preferably a vegetable seed oil such as soybean oil, and the thickening wax is preferably a polyolefin wax such as polyethylene or polypropylene, an ethylene vinyl acetate co-polymer (EVA), or natural waxes or wax esters such as bees wax or candililla wax.

### CROSS REFERENCE TO RELATED APPLICATION

This application is a continuation-in-part of copending application Ser. No. 09/994,416 filed Nov. 27, 2001.

### BACKGROUND OF THE INVENTION

The present invention relates to an emollient gel useful as a lubricant, carrier, thickener or as an ingredient in cosmetics, and more particularly to an emollient gel useful as a substitute for petrolatum in such applications.

Petrolatum has been used in industry for a long period of time in lubricants, cosmetics, sunscreens, lip balms, ink additives, coatings, and the like. Petrolatum, because of its high viscosity and good solubility, is used as a carrier for other additives and because of its high wax content, is an excellent lubricant. Petrolatum is a by-product of the oil refining process and is produced as a result of de-waxing crude oil. It can be sold relatively inexpensively and is on occasion in short supply.

Problems arise with the use of petrolatum however. For example, petrolatum leaves a slight greasy film that can be undesirable in many applications. Also, petrolatum has a relatively narrow range of melt points, and will soon be in very short supply. The petroleum industry is in the process of switching a large number of its refining processes over to what is known as Group III oils which are much cleaner and free of pollutants. These oils will be used heavily in the manufacture of engine oils and other products that are environmentally sensitive. With this conversion to the Group III oils, the process no longer calls for dewaxing, as the waxes will be broken up and treated by polymers and kept in the oil itself. This means the petrolatum that was once available from refineries producing motor oil base stocks will not longer be generated. As a result, it is desirable that a substitute for petrolatum be developed which has all of the advantages of petrolatum but which minimizes its disadvantages.

### SUMMARY OF THE INVENTION

The present invention provides an emollient gel useful as a replacement for petrolatum. The emollient gel has all of the desirable qualities found in petrolatum plus has additional attributes that make it superior to petrolatum.

The emollient gel is composed of an oil, or blend of oils, and a wax, or blend of waxes. The gel is typically composed of about 40% to about 98% by weight oil, preferably from about 60% to about 90%, and most preferably from about 70% to about 80% oil, and about 2% to about 60% by weight wax, preferably from about 5% to about 50%, and most preferably from about 5% to about 30% wax. The oil may be obtained from various sources such as petroleum derived oils, vegetable oils, animal oils, and the like, but is preferably a vegetable oil such as macadamia oil, palm oil, coconut oil, wheat germ oil, avocado oil, almond oil, sunflower oil, safflower oil, canola oil, soybean oil and hydrogenated versions of these oils. The oils may have a “low” oleic acid content of from 0-23%, or may have a “high” oleic acid content of from 45-85%, and is preferably a blend of both types. The wax that is used with the oil may be oxidized or non-oxidized, but if of the oxidized type is oxidized to have an acid value of from about 10 to about 45, preferably from about 15 to about 40, and most preferably to have an acid value of 15 to 30. The oxidized waxes used also have an average molecular weight (\overline{M}w) of from about 700 to about 3,000, preferably from about 1,500 to about 2,000. The melt point of oxidized waxes used ranges from about 125° F. to about 330° F. while the melt point of the emollient gel composition itself ranges from about 100° F. to about 315° F. The oxidized waxes that may be used are selected from classes of oxidized waxes such as petroleum waxes, synthetic waxes, and polyolefin waxes. Preferred non-oxidized waxes are microcrystalline wax, beeswax, candililla wax, berry wax, montan wax, polyethylene wax and ethylene vinyl acetate (EVA) polymers or copolymers. Preferred oxidized waxes are oxidized microcrystalline wax, oxidized fisher tropsch waxes, oxidized polyethylene waxes and oxidized polypropylene waxes. The gel can also be fortified with stabilizers, vitamins, minerals, skin conditioning agents, colorants, surfactants, opacifiers, fragrances, and the like depending on its desired end use.

The choice of the base oil used depends on the end use application and cost consideration. Some oils are selected because of their high lubricating qualities, while others are selected because of their resistance to oxidation and thermal breakdown. When the proper oil is selected, a wax is then selected and added to the oil at the desired level, depending on the viscosity and melt point desired. As compared to petrolatum, these gels leave less of a greasy film, have controllable melt points through proper wax selection, provide superior moisture barrier protection, are very resistant to oxidation, and preferably are derived from a renewable source, i.e. an agricultural product such as vegetable oil. Depending on the oils and waxes used, the gels may be used in certain personal care products, especially cosmetics.

In one particularly preferred composition, the emollient gel comprises from about 50% to about 98% by weight of a blend of oils and from about 50% to about 2% by weight of microcrystalline wax. It has been discovered that if the blend of oils contains from about 0.5% by weight to about 20% by weight of a “high” oleic acid oil, and “high” is defined as having 45-85% oleic acid content, the amount of microcrystalline wax utilized in the gel can be at the lower end of the above range, and then the remainder of the gel can be composed of other oils, as defined herein.

An example of a formula using microcrystalline wax without a high oleic acid oil is:

| | |
|---|---|
| Soy or canola oil | 50-70% |
| Microcyrstalline wax | 30-50% |

An example of a formula using microcrystalline wax with a high oleic acid oil is:

| | |
|---|---|
| Soy or canola oil | 70-90% |
| Hydrogenated soy oil | 10-20% |
| Microcrystalline wax | 5-30% |

In another particularly preferred composition, the emollient gel comprises from about 65-92% vegetable oil having a low oleic acid content (0-23% oleic acid), from about 3-92% vegetable oil having a high oleic acid content (45-85% oleic acid), and about 8-30% of an ethylene vinyl acetate (EVA) copolymer. An example of a formula using EVA copolymer and a high oleic acid oil is:

| | |
|---|---|
| Safflower oil (70% oleic) | 88% |
| EVA copolymer (AC 400) | 12% |

An example of a formula using EVA copolymer and a blend of oils is:

| | |
|---|---|
| Soy or canola oil (23% oleic) | 73% |
| Safflower oil (70% oleic) | 10% |
| EVA copolymer (AC 400) | 17% |

These gels can also be used to replace petrolatum in additives used in inks and paint to improve gloss, rub and abrasion resistance, and surface hardness. Tests on various ink formulations using a soy gel emollient produced better gloss with lower treat levels than was used in the past, resulting in lower manufacturing costs.

In lubricants, petrolatum is typically used to make rust inhibitors. The petrolatum carries other additives such as overbased calcium sulfonate, barium sulfonate, oxidized waxes, and others which leave a difficult to remove rust inhibiting film on metal surfaces protecting them from oxidation. The problem is the petrolatum itself is prone to oxidation and breakdown which then transfers to the metal surface and the rust inhibitor fails. When using a gel of the present invention produced from a canola or palm oil, the oxidation point is significantly lengthened. Tests have demonstrated that petrolatum begins to oxidize after 15 days and after 90 days was severely oxidized, while a canola gel produced in accordance with the present invention did not oxidize at all in 90 days. These results indicate that a vegetable oil gel produced in accordance with the present invention is much more desirable for use as a carrier for rust inhibiting additives than petrolatum.

In lubricants such as greases, drawing oils, or stamping oils petrolatum is used to help increase viscosity and impart slip. However, a vegetable gel made from soy or canola in accordance with the present invention is superior to petrolatum as the melt points can be controlled and tailored to the end use enabling the lubricant to maintain a higher viscosity at higher temperatures. The thickening wax in the oil also acts as a good boundary lubricant for metal drawing and stamping and presents some extreme pressure characteristics to the end product, resulting in higher film strengths. The wax also assists in making the lubricant less susceptible to being washed off by water keeping a lubricating film on the moving surface.

It has also been found that an oil gel produced in accordance with the present invention makes an excellent railroad track grease, especially a gel based on soy oil, in that it is bio-degradable, non-polluting, and is not easily washed off the metal track surface and can be manufactured at a reasonable cost. This same product, when the thickening wax is used in conjunction with a slip agent such as calcium carbonate and a pour point depressant such as Rohmax 10-771, can be used in very cold climates to minus 30° F. and still lubricate, 771 while mineral oil greases harden and flake at such low temperature.

### DETAILED DESCRIPTION OF THE INVENTION

The emollient gel of the present invention is composed of an oil, or blend of oils, and a thickening wax, or blend of waxes. The gel is typically composed of about 40% to about 98% oil, and about 2% to about 60% wax. The melt point of the emollient gel composition ranges from about 100° F. to about 315° F. Preferred emollient gel products are those formulated to have low, medium and high melt points depending on the desired end use of the gel. Accordingly, the preferred melt point for the “low” melt point product is between 115° F.-160° F. while for the “medium” melt point product it is between 170° F.-215° F. and for the “high” melt point product it is between 300° F.-315° F.

The oil may be obtained from various sources such as petroleum derived oils, vegetable oils, animal oils, and the like. The thickening waxes that are used with the oil may be oxidized or non-oxidized, but if of the oxidized type is oxidized to have an acid value of from about 10 to about 45, preferably from about 15 to about 40, and have an average molecular weight (\overline{M}w) of from about 700 to about 3,000, preferably from about 1,500 to about 2,000. The oxidized waxes that may be used are selected from classes of waxes such as petroleum waxes, synthetic waxes and polyolefin waxes. If the thickening waxes used are non-oxidized, they are selected from classes of waxes such as microcrystalline waxes or natural waxes such as candililla wax, bees wax, montan wax, or berry wax. The melt point of the oxidized waxes used ranges from about 100° F. to about 330° F. and the melt point of the non-oxidized waxes used ranges from 100° F. to about 170° F.

An oil is present in the emollient gel composition of the present invention in amounts of about 40% to about 98% by weight, preferably from about 60% to about 90%, and most preferably from about 70% to about 80%. A suitable oil may be selected from the group which includes petroleum derived oils, such as USP white oil, paraffinic oils, napthenic oils, mineral seal oils and petroleum solvents, but also olefin oligomers and low molecular weight polymers, as well as vegetable and animal oils and derivatives of such oils. The petroleum derived oils which may be employed are relatively high boiling materials containing only a minor proportion aromatic hydrocarbons. In this regard, the aromatic hydrocarbons should preferably be less than 30% and more particularly less than 15% of the oil, as measured by the fraction of aromatic carbon atoms. More preferably, the oil may be essentially non-aromatic. The oligmers may be polypropylenes, polybutenes, hydrogenated polyisoprenes, hydrogenated polybutadiens, or the like having average molecular weight between about 350 and about 10,000. Suitable vegetable and animal oils include glycerol esters of the usual fatty acids and polymerization products thereof. Other useful oils can be found in the families of conventional dibenzoate, phosphate, phthalate esters, as well as esters of mono- or polyglycols. Examples of such oils include, but are not limited to dipropylene glycol dibenzoate, pentaerythritol tetravenzoate, 2-ethylhexyl diphenyl phosphate, polyethylene glycol 400-di-2-ethylhexoate; butyl benzyl phthalate, dibutyl phthalate and dioctylphthalate.

The oil is preferably selected from hydrocarbons, fatty acids, fatty alcohols and esters. Hydrocarbons that may be employed include mineral oil, polyolefins such as polydecene, and paraffins such as isohexadecane (e.g. Permethyl 99® and Permethyl 101®).

Fatty acids and alcohols will have from 10 to 30 carbon atoms. Illustrative of this category are pelargonic, lauric, myristic, palmitic, stearic, isostearic, hydroxystearic, oleic, linoleic, ricinoleic, arachidic, behenic and erucic acids and alcohols.

Oily ester emollients may be those selected from one or more of the following classes:

1. Triglyceride esters such as vegetable and animal fats and oils. Examples include castor oil, cocoa butter, safflower oil, cottonseed oil, corn oil, rapeseed oil, canola oil, cottonseed oil, olive oil, cod liver oil, almond oil, avocado oil, palm oil, sesame oil, squalene, Kikui oil and soybean oil.

2. Acetoglyceride esters, such as acetylated monglycerides.

3. Ethoxylated glycerides, such as ethoxylated glyceryl monostearate.

4. Alkyl esters of fatty acids having 10 to 20 carbon atoms. Methyl, isopropyl, and butyl esters of fatty acids are useful herein. Examples include hexyl laurate, isohexyl laurate, isohexyl palmitate, isopropyl palmitate, cetyl palmitate, decyl oleate, isodecyl oleate, hexadecyl stearate, decyl stearate, isopropyl isostearate, diisopropyl adipate, diisohexyl adipate, dihexyldecyl adipate, diisopropyl sebacate, lauryl lactate, myristyl lactate, and cetyl lactate.

5. Alkenyl esters of fatty acids having 10 to 20 carbon atoms. Examples thereof include oleyl myristate, oleyl stearate, and oleyl oleate.

6. Ether-esters such as fatty acid esters of ethoxylated fatty alcohols.

7. Polyhydric alcohol esters. Ethylene glycol mono and di-fatty acid esters, diethylene glycol mono- and di-fatty acid esters, polyethylene glycol (200-6000) mono- and di-fatty acid esters, propylene glycol mono- and di-fatty acid esters, polypropylene glycol 2000 monooleate, polypropylene glycol 2000 monostearate, ethoxylated propylene glycol monostearate, glyceryl mono- and di-fatty acid esters, polyglycerol polyfatty esters, ethoxylated glyceryl monostearate, 1,2-butylene glycol monostearate, 1,2-butylene glycol distearate, polyoxyethylene polyol fatty acid ester, sorbitan fatty acid esters, and polyoxyethylene sorbitan fatty acid esters are satisfactory polyhydric alcohol esters.

8. Wax esters such as spermaceti, myristyl myristate, and stearyl stearate, candililla, beeswax.

The oils that find usefulness in the present invention can be any number of different oils but the inventors have discovered that the vegetable oils are particularly advantageous. Vegetable oils having low oleic acid content (0-23%) as well as high oleic acid content (45-85%) are useful individually or as blends. The following examples are representative of the types of vegetable seed oils that can be used to manufacture an emollient gel in accordance with the present invention: sunflower seed oil, canola or rapeseed oil, castor oil, meadowform seed oil, and jojoba oil. Each of these oils has sufficient saturation so that it does not oxidize and is very stable over the end product's useful life.

Experimentation has shown that seed oils that exhibit enhanced anti-oxidant effect perform better in most applications. Thus, other vegetable seed oils, which initially are highly unsaturated and are therefore normally less stable, may also be used in applications where high stability is desired. Stability and resistance to oxidation may be enhanced by genetic means or by chemical processing of the oils. These other vegetable seed oils may include, for example, corn oil, olive oil, peanut oil, sesame oil, coconut oil, soybean oil, macadamia oil, babassu oil, squalame oil, safflower oil, apricot kernel oil, mink oil, almond oil, avocado oil, rice bran oil, wheat germ oil, grape seed oil, borage oil and evening primrose oil. Where high stability is not required, any of the above oils may be used “as is,” but when higher stability is desired, these oils should be processed to provide enhanced stability.

The less stable oils listed can be used, but as noted are preferably stabilized with respect to oxidation. The measure of oleic acid concentration is a measure of the number of saturation of double bonds in the oil's molecules. Processing by hydrogenation or other means to increase the degree of saturation will improve the stability of any of these oils whether they were initially of the high oleic acid variety or not. The less stable oils listed will make emollient gels that are functional, but not optimum, because of poorer stability when compared to the oils that are stabilized through genetic means (cultured to have high oleic acid contents) or chemo/mechanically, or both.

Good predictors of oxidation stability in oils include a naturally high oleic acid content in seed oils (oleic acid is saturated, and therefore more stable than other, nonsaturated acids that could be present). High oleic acid contents are indicated by the following test results:

Iodine Number, AOCS Claimed 1-25: <86

Another way to achieve a high degree of saturation is through hydrogenation in a processing plant.

Tests for oxidation stability: ASTM D2440, ASTM D2112.

Essentially, the seed oils are blends of paraffmic or iso-paraffinic molecules of 16 to 20 carbons that contain one or more double bonds (i.e. unsaturated bonds). These bonds are weak points in the molecular structure and are the first sites of oxidative degradation. Therefore, molecules with the lowest number of double bonds are desired. Vegetable oil with 16 carbon atoms and only one double bond is particularly desirable. This particular molecule is called oleic acid. Preferred oils are those having enhanced oleic acid concentrations due to genetic screening and selective breeding or by chemical or mechanical means.

The vegetable seed oils can be blended with themselves or with other oils for use in the emollient gel of the present invention. Also, other fluids may be added to improve stability or oxidation resistance, to lower the cost of the resulting blend, or to improve the functional characteristics of the vegetable seed oil. These other oils may be those refined from natural petroleum oils, or may be themselves synthetic hydrocarbons such as poly-alpha olefms, organic or inorganic esters, or alkyl silicone compounds. Thus, blends with other oils may be used so long as these other oils impart enhanced stability, or at least do not decrease the stability of the vegetable seed oil or the overall emollient gel composition itself.

Other substances which include hydrogenated animal, fish and vegetable fats and oils such as hydrogenated tallow, lard, soya oil, cottonseed oil, castor oil, menhadin oil, cod liver oil, and the like, and which are solid at the room temperature by virtue of their being hydrogenated, have also been found to be useful with respect to finctioning as an oil equivalent. These hydrogenated materials are often referred to in the adhesive industry as “animal or vegetable waxes.”

A thickening wax is present in the emollient gel composition of the present invention in amounts of from about 2% to about 60% by weight, preferably about 5% to about 50% and most preferably from about 5% to about 30%. The thickening wax may be oxidized or non-oxidized. If non-oxidized, the wax is preferably selected from microcrystalline wax, beeswax, candililla wax, berry wax, paraffin wax, polyethylene wax and ethylene vinyl acetate (EVA) polymers and copolymers. On the other hand, if the wax used is an oxidized wax, the oxidized wax is oxidized to have an acid number of from about 10 to about 45, preferably from about 15 to about 40, and most preferably to have an acid value of 15 to 30. Oxidation refers to the transfer of electrons between two substances, and particularly refers to a reaction in which oxygen combines chemically with another substance. The oxidized waxes also have an average molecular weight of (\overline{M}w) of from about 700 to about 3,000, preferably from about 1,500 to about 2,000. The melt point of oxidized and non-oxidized waxes used ranges from about 125° F. to about 330° F. while the melt point of the emollient gel composition itself ranges from about 100° F. to about 315° F., preferably from about 115° F. to about 160° F. for a low melt point product, from about 170° F. to about 215° F. for a medium melt point product, and from about 300° F. to about 315° F. for a high melt point product.

Among the useful waxes are:

1. low molecular weight, that is, 500-6000 (\overline{M}w), polyethylene wax having a hardness value, as determined by ASTM method D-1321, of from about 0.1 to 120, and having an ASTM softening point of from about 65° C. to 120° C.; and high molecular weight, that is greater than 6,000 (\overline{M}w) polyethylene;

2. low molecular weight, that is, 500-6000 (\overline{M}w), polypropylene wax; and high molecular weight, that is, greater than 6000 (\overline{M}w) polypropylene wax;

3. petroleum waxes such as paraffm wax having a melting point of from about 50° C. to 80° C. and microcrystalline wax having a melting point of from about 50° C. to 100° C., the latter melting points being determined by ASTM method D127-60. One particularly preferred microcrystalline wax is available from Honeywell International of Morristown, N.J. under the trade designation “Astorwax 3040”;

4. synthetic waxes made by polymerizing carbon monoxide and hydrogen such as Fischer-Tropsch wax;

5. polyolefin waxes. As used herein, the term “polyolefin wax” refers to those polymeric or long-chain entities comprised of olefinic monomer units. Polyolefin waxes are commercially available from Eastman Chemical Co. under the trade name designation “Epolene”. Also, another particularly desirable wax is a cross-linked oxidized, polyolefin wax having a melt point between 120° F. to 200° F. available from Venture Chemical, Inc. under the trademark “VEN-WAX”. The materials which are preferred for use in the composition of the present invention have a Ring and Ball softening point of from about 100° C. to 170° C. As should be understood, each of these waxes are solid at room temperature; and,

6. natural wax and wax esters such as candililla wax, bees wax, or berry wax having a melting point of 140° F.-165° F., an acid number of about 17-24, and a saponification number of about 43-103. Natural waxes are available from Frank B. Ross Co., Inc. of Jersey City, N.J.

The acid value of the oxidized wax is determined by ASTM method D1386. Above an acid number of 45, i.e. 46 and higher, the emollient gel becomes extremely heavy, thick and difficult to manufacture and process. Below an acid number of 5, i.e. 4 and lower, the emollient gel separates into its individual components and thus becomes unusable.

The preferred oxidized wax used in this product is the Honeywell Specialties Group AC-629 polyethylene. However, the following waxes are also highly desirable: paraffm wax, microcrystalline wax, Fisher-Tropsch wax, polyethylene waxes (high and low molecular weight), polypropylene waxes (high and low molecular weight), Ethyl Vinyl Acetate (EVA) co-polymer, and natural wax esters such as candililla wax and bees wax. One particularly useful Fischer-Tropsch wax is ParafLint A6 available from Moore & Munger with a melt point ranging from 185° F. to 220° F.

The melting points are preferably categorized as follows: Melting points of paraffin waxes range from 125° F. to 195° F. Melting point of microcrystalline waxes range from 120° F. to 190° F. Melting points of polyethylene waxes range from 200° F. to 230° F. Melting point of polypropylene waxes range from 275° F. to 330° F. Melting points of natural wax esters range from 140° F.-165° F.

The gel can also be fortified with additives such as vitamins, minerals, skin conditioning agents (e.g. humectants such as polyethylene glycol, sorbitols or glycerins), surfactants, opacifiers, colorants, fragrances and the like in amounts effective to accomplish their respective functions.

A particularly advantageous additive that may be employed with the gel when used in lubricants is a slip agent, such as calcium carbonate, which provides the gel with low friction and high slip properties. This property is especially useful when the gel is formulated as a track grease to reduce friction between railroad wheels and the track on curves. Another useful slip agent is Synester GY-10, a branched chain oleic ester, available from Lubrizol Corporation. Yet, another slip agent is SST-4SO, a sintered polytetrafluoroethylene (PTFE) material with a particle size of 3-4 microns, available from Shamrock Technologies. From 0.1% to 5% by weight, preferably from 1% to 2%, of a slip agent can be used when desired.

Another advantageous additive is a pour point depressant such as Rohmax 10-771 available from Rohmax USA, a polymer blend based on long chain methacrylic acid esters and rapeseed oil. This additive is added to the gel to control its cold flow properties so that the gel will flow or be pliable in cold temperatures. From 0.1% to 5% by weight, preferably from 2% to 3%, of a pour point depressant can be used when desired.

The gel is prepared by adding a desired oil and thickening wax, in the appropriate amounts (depending on the end use), to a jacketed kettle and then heating and stirring the raw materials until a homogeneous liquid mixture is obtained. The kettle should preferably be closed top and pressurized to minimize the loss of any volatiles. This mixture is preferably heated to a temperature about 10° F. above the melt point of the mixture, which is typically determined by the wax's highest melt point. While agitating, the homogeneous liquid mixture then is pumped to a votator having a cooling jacket through which a cooling fluid, such as liquid nitrogen, circulates to cool the mixture as it is pumped through the votator. As the mixture proceeds downstream through the votator, it agglomerates and is homogenized therein to the desired particle size by the blades within the votator. The cooling jacket of the votator will typically maintain a continuous temperature of between 10° F. and 40° F. so that a discharge temperature of between 90° and 110° F. may be obtained for the product. The discharge temperature preferably should not exceed 110° F. The cooling temperature used in the votator will determine the particle size of the end product gel, i.e. a cooler temperature will produce larger particles while a relative warmer temperature will produce small particles. Votators are available from numerous sources, such as Cherry-Burrell Company.

Alternately, the end product can be prepared by adding a desired oil and thickening wax, in the appropriate amounts (depending on the end use), to a kettle or reactor which is preferably jacketed, closed top and pressurized. The raw materials are then heated and stirred, as noted previously, until a homogeneous liquid mixture is obtained. While continuing to agitate the mixture in the kettle, and continuously scraping the inner surface of the kettle, the mixture is cooled at a rate of 5° F.-6° F. per 10 minute intervals until the desired particle size is obtained in a homogeneous gel form. The product is finally discharged at between 90° F. to 110° F. The discharge temperature preferably should not exceed 150° F.

Yet another method involves the use of a colloid mill. In this method, the end product can be prepared by adding a desired oil and thickening wax, in the appropriate amounts (depending on the end use), to a kettle or reactor which is preferably jacketed, closed top and pressured. The raw materials are then heated and stirred, as noted previously until a homogeneous liquid mixture is obtained. While continuing to agitate the mixture in the kettle, and continuously scraping the inner surface of the kettle, the mixture is rapidly cooled to agglomerate the mixture. The agglomerated mixture is then pumped at a temperature of between 115° F. to 120° F. to a colloid mill where the mixture is homogenized to the desired particle size.

The invention is further illustrated by way of the following examples:

### EXAMPLE 1

Railroad Track Grease (summer formula)

| Ingredient | Supplier | Wt % added |
|---|---|---|
| Refined soybean oil | Archer, Daniels, & Midland | 91.5 |
| AC 629 oxidized polyethylene | Honeywell | 8.0 |
| Synester GY-10 | Lubrizol Company | 0.5 |

The soy oil is the carrier, the AC 629 is the rheology builder, and the Synester GY-10 is the high molecular weight lubricating polymer.

Benefits of this product is it is bio-degradable, non-toxic, and non-polluting. On a Timken bearing test, this product also has a 55 lb. O.K. load which is quite good for a track grease, most of which have about a 30 O.K. load.

### EXAMPLE 2

| Ingredient | Ink Additives Supplier | Wt % added |
|---|---|---|
| Refined soybean oil | Archer, Daniels, & Midland | 80 |
| AC 629 oxidized polyethylene | Honeywell | 20 |

20 percent of the above formula was added into a heatset ink additive containing polytetrafluorethylene (PTFE), soy alkyd, microcrystalline wax, and ink oil. This product was used to replace petrolatum. On a standard rub test the product containing this additive performed better than the standard containing petrolatum at a significant cost savings.

### EXAMPLE 3

| Ingredient | Tube Bending Lubricant Supplier | Wt % added |
|---|---|---|
| Refined soy oil | Archer, Daniels, & Midland | 66 |
| Ven-Wax | Venture Chemical | 30 |
| SST-4SO | Shamrock Technologies | 2 |
| Synester GY-25 | Lubrizol Corporation | 2 |

Ven-Wax is an oxidized fischer-tropsch available from Venture Chemical. This formula provided superior anti-welding characteristics as compared to other tube bending oils. The high viscosity carrier with a soft, low melt point lubricating polymer provided excellent coefficient of friction (c.o.f.).

### EXAMPLE 4

| Ingredient | Grease Additive Supplier | Wt % added |
|---|---|---|
| Refined soybean oil | Archer, Daniels, & Midland | 58 |
| AC 629 oxidized polyethylene | Honeywell | 12 |
| SST 4SO | Shamrock Technologies | 15 |
| Bismuth Trioxide | Shepherd Chemical | 15 |

This additive, when added to a lithium grease at a 5-6% by weight treat level gives a Timken O.K. load value of 80 which is very high. This formula thickens the mix and keeps the rest of the additives in suspension while providing a hard lubricating film.

### EXAMPLE 5

| Ingredient | Emollient Additive Supplier | Wt % Added |
|---|---|---|
| Refined Canola Oil | Cargill | 68 |
| Refined Soybean Oil | Archer, Daniels, & Midland | 20 |
| Candililla or Bees Wax | Frank B. Ross Co. | 7 |
| Hydrogenated Soy Oil | Archer, Daniels, & Midland | 5 |

This additive, when used in a cosmetic formula at treat levels of 2-20%, provides natural moisture barrier protection with no skin irritation due to the high level of vitamin E. The preferred candililla and bees waxes should have an acid number of from 17-24, melt points from 140° F.-165° F., and a suponification number of from 43-103.

### EXAMPLE 6

| Ingredient | Emollient Additive Supplier | Wt % Added |
|---|---|---|
| Refined Canola Oil | Archer, Daniels, & Midland | 56.5 |
| Refined Soybean Oil | Cargill | 20 |
| Refined High Oleic | California Oils Corp. | 5 |
| Safflower Oil | | |
| AC-400 | Honeywell Specialties | 18.5 |

AC-400 is an EVA co-polymer available from Honeywell Specialties Group. This additive, when used in a lipstick, provided superior gloss and resistance to oil separation when heated to elevated temperatures as compared to a lipstick containing conventional petrolatum.

### EXAMPLE 7

| Ingredient | Chain Lubricant Supplier | Wt % added |
|---|---|---|
| Refined canola oil | Cargill, Inc. | 95 |
| AC 629 oxidized polyethylene | Honeywell | 5 |

This product formula was selected because it offered a heavier, higher viscosity oil that resists being washed out by water. This resistance to washout is a result of the oxidized wax.

### EXAMPLE 8

Various mixes containing EVA copolymer were made and tested for syneresis (separation). The compositions and test results were as follows:

| Formulation | | Test Result |
|---|---|---|
| Soy or canola oil (23% oleic acid) | 80% | This formulation had |
| | | syneresis |
| EVA copolymer | 20% | |
| Soy or canola oil (23% oleic) | 76% | No syneresis |
| Safflower oil (70% oleic) | 5% | |
| AC 400 EVA | 19% | |
| Soy or canola oil (23% oleic) | 75% | No syneresis |
| Safflower oil (70% oleic) | 10% | |
| AC 400 EVA | 15% | |
| Safflower oil (70% oleic) | 88% | No syneresis |
| AC 400 EVA | 12% | |
| Soy or canola oil (23% oleic) | 75% | No syneresis |
| Hydrogenated veggie oil | 15% | |
| AC 400 EVA | 10% | |
| Soy or canola oil (23% oleic) | 70% | Undesirable, too thick |
| Safflower oil (70% oleic) | 5% | |
| AC 400 EVA | 25% | |

EVA polymer levels over 30% were too thick and unacceptable. Also, substituting a modified polyethylene like Epolene C-18 instead of AC-400, provides the same result. The EVA formulations will primarily be useful for cosmetic reasons.

### EXAMPLE 9

In one particularly preferred composition, the emollient gel comprises from about 50% to about 98% by weight of a blend of oils and from about 50% to about 2% by weight of microcrystalline wax. It has been discovered that if the blend of oils contains from about 0.5% by weight to about 20% by weight of a “high” oleic, eladic, or steric acid hydrogenated oil, and “high” is defined as having at least 45-85% of oleic acid, or a combination of oleic, eladic, and steric acids, the amount of microcrystalline wax utilized in the gel can be at the lower end of the above range, and then the remainder of the gel can be composed of other oils. The hydrogenated oil can also have a lower amount of oleic acid and a higher level of eladic acid, which is a transconfiguration of oleic acid. A higher degree of hydrogenation will convert oleic acid to eladic acid, and to steric acid, which is also effective in the gel. The type of hydrogenated oil selected depends on the cost requirements and application. The following are examples of specific formulations utilizing microcrystalline wax:

| | | |
|---|---|---|
| 9.a | Soybean oil 23% oleic acid | 70% |
| | Microcrystalline wax | 30% |
| 9.b | Soybean oil 23% oleic acid | 75% |
| | Hydrogenated soybean oil | 5% |
| | Microcrystalline wax | 20% |
| 9.c | Soybean oil 23% oleic acid | 80% |
| | Hydrogenated soybean oil | 10% |
| | Soybean oil 70% oleic acid | 5% |
| | Microcrystalline wax | 5% |

The preferred formulation is 9b listed above. The preferred microcrystalline wax is one having the following specifications:

| | ASTM | | | |
|---|---|---|---|---|
| Test Description | Method | Minimum | Maximum | Typical |
| Melting Point ° F./° C. | D127 | 125/52 | 145/62.8 | 130/54 |
| Penetration @ 77° F./25° C. | D1321 | 35 | 45 | 40 |
| Color, ASTM | D1500 | | 0.5 | 0.5 |
| Oil Content, Wt % | D721 | | 4.0 | 2.0 |
| Flash, PM ° F./° C. | D93 | 470/243 | | 510/288 |
| Viscosity, SUS, | D2161 | 90 | | 96 |
| 210° F./98.9° C. | | | | |
| Viscosity, cSt, | D445 | 18.0 | | 19.4 |
| 210° F./98.9° C. | | | | |
| Odor | D1833 | | 2 | 1 |

A particularly preferred microcrystalline wax is “Astorwax 3040” available from Honeywell International.

I claim:

1. An emollient gel composition, comprising:
from about 40% to about 98% by weight of an oil or blend of oils; and
from about 2% to about 60% by weight of thickening wax.

2. The composition of claim 1 wherein said oil is selected from the group consisting of petroleum derived oils, vegetable oils and animal oils.

3. The composition of claim 1 wherein said oil is selected from the group consisting of sunflower seed oil, canola oil, rapeseed oil, castor oil, meadowform seed oil, jojoba oil, corn oil, olive oil, peanut oil, sesame oil, coconut oil, soybean oil, macadamia oil, babassu oil, squalame oil, safflower oil, apricot kernel oil, mink oil, almond oil, avocado oil, rice bean oil, wheat germ oil, grape seed oil, borage oil, and evening primrose oil.

4. The composition of claim 1 wherein said wax has an average molecular weight of from about 700 to about 3,000.

5. The composition of claim 1 wherein said wax has a melt point of from about 100° F. to about 330° F.

6. The composition of claim 1 wherein said wax is selected from the group consisting of paraffm wax, microcrystalline wax, Fisher-Tropsch wax, and polyolefm waxes.

7. The composition of claim 1 wherein said wax is selected from the group consisting of oxidized microcrystalline wax, oxidized polyethylene wax, oxidized fischer-tropsch wax, and oxidized polypropylene wax.

8. The composition of claim 1 wherein said wax is a natural wax selected from the group consisting of candililla wax, bees wax, berry wax, montan wax, Japan wax, spermacetti wax, carnauba wax, and ozokerite wax.

9. The composition of claim 1 wherein said wax is selected from a group of ethyl vinyl acetate co-polymers (EVA).

10. The composition of claim 1 further including a high oleic acid oil with oleic acid values from 45%-80%.

11. The composition of claim 1 further including a hydrogenated vegetable oil.

12. The composition of claim 1 further including a slip agent.

13. The composition of claim 1 further including a pour point depressant.

14. A method of making an emollient gel composition, comprising the steps of:
mixing an oil and thickening wax to form a gel containing from about 40% to about 98% by weight of said oil and from about 2% to about 60% by weight of said wax; heating the blend to a temperature above the melt point of said wax; agitating the blend while heating until a homogeneous liquid mixture is obtained; cooling the mixture to form agglomerates; and homogenizing the agglomerates to form a gel.

15. The method of claim 14 wherein said oil is selected from the group consisting of petroleum derived oils, vegetable oils, and animal oils.

16. The method of claim 14 wherein said oil is selected from the group consisting of sunflower seed oil, canola oil, rapeseed oil, castor oil, meadowform seed oil, jojoba oil, corn oil, olive oil, peanut oil, sesame oil, coconut oil, soybean oil, macadamia oil, babassu oil, squalame oil, safflower oil, apricot kernel oil, mink oil, almond oil, avocado oil, rice bean oil, wheat germ oil, grape seed oil, borage oil, and evening primrose oil.

17. The method of claim 14 wherein said wax has a weight average molecular weight of from about 700 to about 3,000.

18. The method of claim 14 wherein said wax has a melt point of from about 100° F. to about 330° F.

19. The method of claim 14 wherein said wax is selected from the group consisting of paraffm wax, microcrystalline wax, Fisher-Tropsch wax, and polyolefin waxes.

20. The method of claim 14 wherein said wax is selected from the group consisting of oxidized microcrystalline wax, oxidized polyethylene wax, oxidized polypropylene wax, and oxidized fischer-tropsh wax.

21. The method of claim 14 wherein said wax is a natural wax selected from the group consisting of candililla wax, bees wax, berry wax, carnauba wax, montan wax, spermacetti wax, Japan wax, and ozokerite wax.

22. The method of claim 14 further including a hydrogenated vegetable oil.

23. The method of claim 14 wherein the steps of cooling the mixture and homogenizing the agglomerates are performed substantially simultaneously in a votator.

24. The method of claim 14 wherein the step of homogenizing the agglomerates is performed in a colloid mill.

25. The method of claim 14 wherein the liquid mixture is cooled at a rate of about 5° F.-6° F. per 10 minute interval in a mixing vessel.

26. An emollient gel composition, comprising:
from about 50% to about 98% by weight of an oil, and from about 2% to about 50% by weight of a microcrystalline wax.

27. An emollient gel composition, comprising:
from about 50% to about 98% by weight of an oil, or a blend of oils with at least one of the said oils comprising a hydrogenated oil, and from 2% to about 30% by weight of a microcrystalline wax.

28. The composition of claim 27 wherein said oil or blend of oils contains an oil selected from the group consisting of petroleum derived oils, vegetable oils and animal oils.

29. The composition of claim 27 wherein said oil or blend of oils contains an oil selected from the group consisting of sunflower seed oil, canola oil, rapeseed oil, castor oil, meadowform seed oil, jojoba oil, corn oil, olive oil, peanut oil, sesame oil, coconut oil, soybean oil, macadamia oil, babassu oil, squalame oil, safflower oil, apricot kernel oil, mink oil, almond oil, avocado oil, rice bean oil, wheat germ oil, grape seed oil, borage oil, and evening primrose oil.

30. The composition of claim 27 wherein said hydrogenated oil is a hydrogenated vegetable oil.

31. The composition of claim 27 wherein said microcrystalline wax has a melt point of from about 50° C. to about 100° C.

32. An emollient gel composition, comprising:
from about 50% to about 98% by weight of a vegetable oil, or blend of vegetable oils with at least one of the said oils comprising a hydrogenated vegetable oil, and from 2% to about 20% of a natural wax selected from the group consisting of candililla wax, bees wax, berry wax, spermacetti wax, carnauba wax, ozokerite wax, or montan wax.

33. The composition of claim 32 wherein said oil or blend of oils contains an oil selected from the group consisting of sunflower seed oil, canola oil, rapeseed oil, castor oil, meadowform seed oil, jojoba oil, corn oil, olive oil, peanut oil, sesame oil, coconut oil, soybean oil, almond oil, avocado oil, rice bean oil, wheat germ oil, grape seed oil, borage oil, and evening primrose oil.

34. The composition of claim 32 wherein said natural waxes have a melt point of about 140° F.-190° F.

35. The composition of claim 32 wherein said natural waxes have a saponification number of about 43-103.

36. An emollient gel composition, comprising:
from about 50% to about 98% by weight of a vegetable oil, or blend of vegetable oils with at least one of the said oils comprising a high oleic acid oil having a 45-85% oleic acid content, and from 8% to 20% of an ethylene vinyl acetate co-polymer (EVA).

37. The composition of claim 36 wherein said oil or blend of oils contains an oil selected from the group consisting of sunflower seed oil, canola oil, rapeseed oil, castor oil, meadow form oil, jojoba oil, corn oil, olive oil, peanut oil, sesame oil, coconut oil, soybean oil, macadamia oil, babassu oil, squalame oil, safflower oil, apricot kernel oil, mink oil, almond oil, avocado oil, rice bean oil, wheat germ oil, grape seed oil, borage oil, and evening primrose oil.

38. The composition of claim 36 wherein the said EVA co-polymer has a melt point of around 198° F.
